(19) United States
(12) Patent Application Publication
(10) Pub. No.: US 2022/0164460 A1
(43) Pub. Date: May 26, 2022

(54) MULTI-USER COLLABORATION TOOL FOR SPREADSHEET APPLICATIONS

(71) Applicant: Kiesewetter GmBH & Co. KG, Konstanz (DE)

(72) Inventor: Tobias Kiesewetter, Konstanz (DE)

(21) Appl. No.: 17/450,753

(22) Filed: Oct. 13, 2021

Related U.S. Application Data
(60) Provisional application No. 63/198,943, filed on Nov. 24, 2020.

(51) Int. Cl. G06F 21/62; G06F 21/53; H04L 29/06

(52) U.S. Cl. CPC G06F 21/62; G06F 2221/033; H04L 63/104; G06F 21/53

(57) ABSTRACT

Electronic spreadsheet data can be among multiple users. A request can be received from within a first spreadsheet application instance on a first electronic device of a first user to grant or change access permission to data in a specified sub-portion of a first spreadsheet to a second user of a second spreadsheet application instance on a second electronic device of the second user. Based on an access permission of the first user meeting a specified access requirement, from within the spreadsheet application on the electronic device of the first user, grant or change an access permission of the second user to the data in the specified sub-portion of the first spreadsheet.

### CLAIM FOR PRIORITY

This application claims the benefit of priority of U.S. Provisional Application Ser. No. 63/198,943, filed Nov. 24, 2020, which is hereby incorporated by reference in its entirety.

### TECHNICAL FIELD

The present disclosure generally relates to, among other things, sharing select spreadsheet data and workflow with multiple users.

### BACKGROUND

Spreadsheet applications allow users to access, manipulate, share, and store data within the applications. Spreadsheet application users may access, manipulate, share, and/or store portions of data within a larger dataset. Depending on a user's status or position, data accessibility, and other factors, accessing data may become cumbersome. As data processing and data science requirements grow, sharing privileged data and maintaining the integrity of such privileged data becomes crucial. However, keeping track of such privileged data may become difficult and cumbersome.

### SUMMARY

In a structured group such as a company or other business entity, people can be assigned ranks that allow them various degrees of access, such as according to their status or position within the organization. For example, a president, vice president, and all members of the C-suite may have the highest level of access or “full access.” Directors and managers below them may have the second highest level of access and the access level decreases as the rank decreases. The access levels may be accompanied by various degrees of access (to data, equipment, policies, salary, etc.). In a structured group, there may be tens or even hundreds of varying levels of access. It may be extremely difficult to keep track of access rights between people of differing rank especially when it comes to collaborating on projects that require access to sensitive information.

Embodiments of the present disclosure propose method and apparatus for sharing electronic spreadsheet data among multiple users. A request from within a first spreadsheet application instance on a first electronic device of a first user is received from the first user to grant or change access permission to data in a specified sub-portion of a first spreadsheet to a second user of a second spreadsheet application instance on a second electronic device of the second user. Based on an access permission of the first user meeting a specified access requirement, from within the spreadsheet application on the electronic device of the first user, granting or changing an access permission of the second user to the data in the specified sub-portion of the first spreadsheet in accordance with the request.

In some embodiments, the spreadsheet application is a database application. In some embodiments, the spreadsheet application is coupled to a database application to selectively import and export data between the spreadsheet and database applications.

In some embodiments, data in the specified sub-portion of the first spreadsheet is shared between the first and second users via data in a shared sandbox document that is separate from the first and second spreadsheets, wherein the shared sandbox document is accessible from within the first and second spreadsheet application instances. In some embodiments, the spreadsheet application instances are database applications. The shared sandbox document may include one or more tasks operable on the data in the shared sandbox document in accordance with access permission associated with the data, associated with the task, or both.

In some embodiments, access permissions include a pass-through sharing access, pass-on approve access, write-approve access, read access, or write access. The pass-on approve and write-approve access permissions are available based on approval from the first user to the second user where the first user has superior access permission than the second user.

In some embodiments, the second user is a member of a closed group of members having the same access permission and granting or changing an access permission to the second user includes granting or changing the access permission to each member of the closed group of members. In some embodiments, the second user is capable of updating the shared sandbox document with one or more tasks defined by the second user in accordance with an access permission of the second user.

In some embodiments, the first and second user each contribute one or more user defined tasks to the shared sandbox document for executing and the one or more user defined tasks are executed on the data within the sandbox.

In some embodiments, a second request from within the first spreadsheet application is received from the first user to grant or change access permission to the data to a third user of a third spreadsheet application instance on a third electronic device of the third user. Based on the access permission of the first user meeting the specified access requirement, from within the spreadsheet application on the electronic device of the first user, grant or change an access permission of the third user to the data in the specified sub-portion of the first spreadsheet. In response, share, between the first, second, and third users, the data in the specified sub-portion of the first spreadsheet in a shared sandbox document that is separate from the first, second, and third spreadsheets and is accessible from within the first, second, and third spreadsheet application instances.

In some embodiments, the second and third users each contribute one or more of data, tasks, or metadata to the shared sandbox document.

According to some embodiments, an apparatus or system for sharing electronic spreadsheet data among multiple users comprises a processor; and a memory device coupled to the processor and having a program stored thereon for execution by the processor to perform the operations and method steps described above.

According to some embodiments, a non-transitory computer readable storage medium storing one or more programs for sharing electronic spreadsheet data among multiple users is provided, the one or more programs comprising instructions which when executed by one or more processors of an electronic device, cause the electronic device to perform the operations and method steps described above.

This Summary is provided to introduce a selection of concepts that are further described below in the Detailed Description. It is not intended to identify key features or essential features of the claimed subject matter, nor is it intended to be used to limit the scope of the claimed subject matter.

### BRIEF DESCRIPTION OF THE DRAWINGS

The disclosed aspects will hereinafter be described in connection with the appended drawings that are provided to illustrate and not to limit the disclosed aspects.

FIG. 1 is a diagram of an example of a system depicting an environment for sharing spreadsheet data.

FIG. 2 is a second diagram of an example of a system depicting an environment for sharing spreadsheet data in with multiple groups of users in accordance with some embodiments.

FIG. 3 is an example showing the process of sharing spreadsheet data with multiple users in accordance with some embodiments.

FIG. 4 is a block diagram of an example of a system depicting a relationship between a user and shared spreadsheet data in accordance with some embodiments.

FIGS. 5-8 depict an example of a user interface for sharing spreadsheet data in accordance with some embodiments.

FIGS. 9A-9B depict an example of a flow diagram for a method of sharing spreadsheet data with multiple users in accordance with some embodiments.

FIG. 10 is a block diagram of an example of a networked system depicting an environment in which embodiments may operate

FIG. 11 is a block diagram of an example of a computer system to implement one or more examples of embodiments.

### DETAILED DESCRIPTION

A particular challenge exists in large organizations to share restricted or privileged data efficiently. Many organizations rely on spreadsheets to monitor, store, manipulate, and share large amounts of data. However, not all users have the same access permissions which makes sharing data across users having differing access permissions difficult, cumbersome, and potentially dangerous. Having the ability to grant or change access to portions of a user's data can help to provide streamlined access to data, such as without waiting for sharing approval. Having the ability to share privileged data within a shared sandbox document accessible by multiple users is advantageous by decreasing risk of data corruption, deletion, or theft, among other benefits. Having the ability to combine proprietary worksheets and sharing data for manipulation by multiple users allows great flexibility and customization for each user.

A system and method can be used to share electronic spreadsheet data among multiple users in an efficient manner. Sharing privileged and/or classified data across multiple users by allowing a first user with a specified access permission requirement to grant or change a second user's access permission can help allow for greater user flexibility and matter management. The inventor has provided a solution that can include granting or changing another user's access permissions to all or a specified sub-portion of a first user's proprietary data from within a spreadsheet application instance (e.g., from within a first user's spreadsheet). Further, the inventor has provided a solution that includes sharing a proprietary, sub-portion of data of a first user with a larger group of one or more users within a shared sandbox document. The sandbox document acts as a safe intermediary to control who gets access to the data without compromising the raw data from the first user's electronic spreadsheet. Further details of the solutions are discussed herein.

The present subject matter will now be discussed with reference to several examples of implementations. It is to be understood that these implementations are discussed for enabling those skilled in the art to better understand and thus implement the embodiments of the present disclosure, rather than suggesting any limitations on the scope of the present disclosure.

Examples disclosed herein are directed to methods, apparatus comprising several modules and apparatus comprising one or more processors and memory embodied with executable instructions for sharing electronic spreadsheet data among multiple users of electronic spreadsheet applications. Using the disclosed examples, a client device of a first user is equipped with an electronic spreadsheet application that includes the first user's proprietary (e.g., private) data. From within the spreadsheet application, the first user can grant or change access to the first user's data to another user (e.g., a second user). Additionally, both the first and the second user can access a shared sandbox document from within the spreadsheet application instances running on each user's separate client devices. The shared sandbox document may include a portion of data from the first user's proprietary data, a portion of data from the second user's proprietary data, tasks, metadata, communication tools (e.g., chat options), and other functionalities.

Having generally provided an overview of some of the disclosed examples, attention is drawn to the accompanying drawings to further illustrate some additional details. The illustrated configurations and operational sequences are provided to aid the reader in understanding some aspects of the disclosed examples. The accompanying figures are not meant to limit all examples, and thus some examples may include different components, devices, or sequences of operation while not departing from the scope of the disclosed examples discussed herein. In other words, some examples may be embodied or may function in different ways than those shown.

It should be noted that the above one or more aspects comprise certain features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

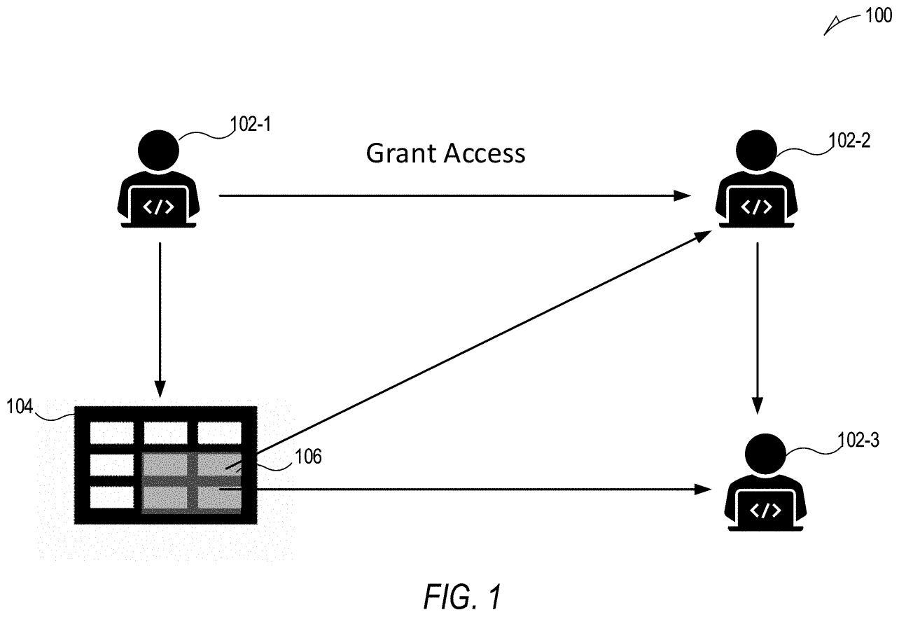

FIG. 1 is a block diagram of a system 100 depicting an arrangement for sharing spreadsheet data of a first user 102-1 with a second user 102-2 and in some embodiments with a third user 102-3. The first user 102-1 is the owner of an electronic spreadsheet 104 including a portion 106. The electronic spreadsheet includes data that is privately owned by the first user 102-1. The first user 102-1 wants to grant the second user 102-2 access to a portion 106 of the data in the electronic spreadsheet 104. The first user 102-1 can grant access to the second user 102-2 from within the electronic spreadsheet application. The second user 102-2 now has access to the portion 106 of data from the first user's electronic spreadsheet 104. Spreadsheet data can include all data within an instance of a user's spreadsheet application (also referred to as “master application”) as well as a portion of all data within the instance of the user's spreadsheet application. Each user has his/her own spreadsheet data.

In some embodiments, the first user 102-1 has given “pass-through access” rights to second user 102-2. The “pass-through access” rights allow the second user 102-2 to “pass-through” the second user's access rights to another user. In such a scenario, the second user 102-2 can grant access to a third user 102-3 to access the first user's portion 106 of data. The third user 102-3 can be granted “pass-through access” since the second user had “pass-through access.” After the access has been granted to the third user 102-3, the third user 102-3 can access the first user's portion 106 of data with the same access level that was granted to the second user 102-2.

In some embodiments, the first user 102-1 has not given the second user 102-2 rights to “pass-through access” to another user. In such a scenario, the second user 102-2 cannot grant access to a third user 102-3 to access the first user's portion 106 of data.

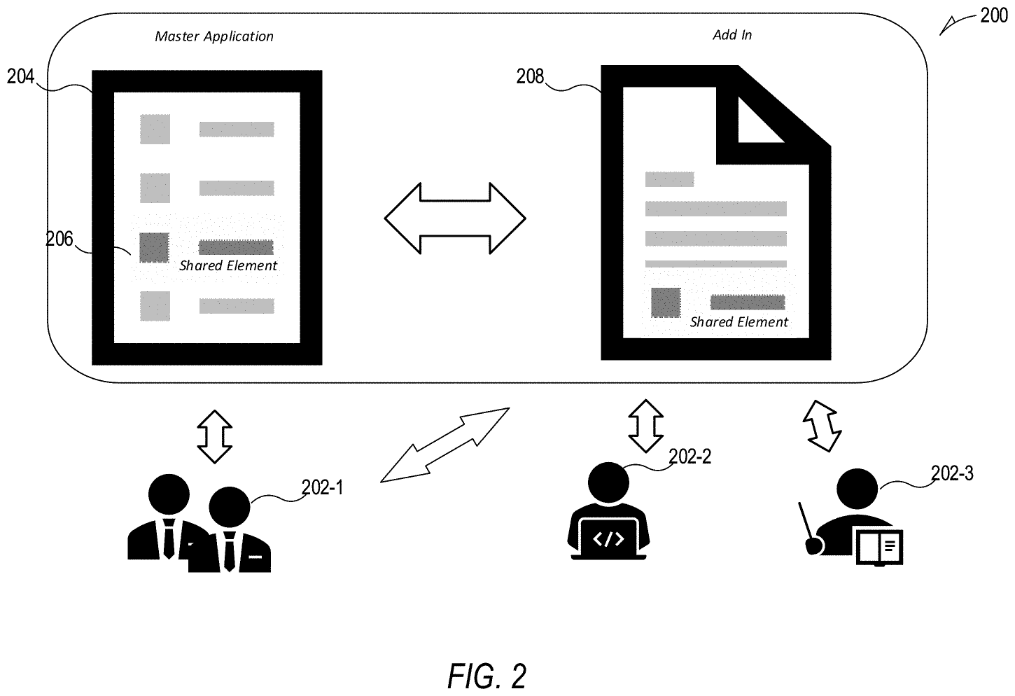

FIG. 2 is a block diagram for sharing electronic spreadsheet data with multiple users. The system 200 depicts an arrangement for sharing spreadsheet data (similar to system 100 in FIG. 1) with multiple users and/or multiple groups of users. Similar to FIG. 1, a first user 202-1 (or group of users having the same access permission) is working on a master application 204 and wants to share a portion 206 of the master application 204. For example, a master application is an instance of a spreadsheet application (e.g., Excel or Pages) run on a specific user's device. Each master application is specific to the user. A master application can include one or more spreadsheets and/or workbooks. A spreadsheet application is used herein referred to as a general audience application such as Excel, to be run on a specific user's device as the user's master application. Rather than sending the whole master application 204 or even just sending the portion 206 as a separate document, the system 200 allows the first user 202-1 to share the portion 206 in a shared add-in document 208 (also referred to herein as a shared sandbox document). The shared add-in document 208 can include multiple shared portions of spreadsheet data from multiple users. Further, each user may have a different view of the shared portions of spreadsheet data in accordance with each user's specific permissions.

For example, user 202-2 may also include a portion of hers or his data into the shared document. Additionally, user 202-3 may include one or more functions (also referred to herein as tasks) to run on the shared data within the add-in document 208. In some embodiments, each of the users 202-1, 202-2, and 202-3 contribute items to the add-in document 208 as well as receive data from the add-in document to add to hers or his own electronic spreadsheet. Each user, based on access permissions of the user, the data, or the tasks, can add or receive various contents of the add-in document 208.

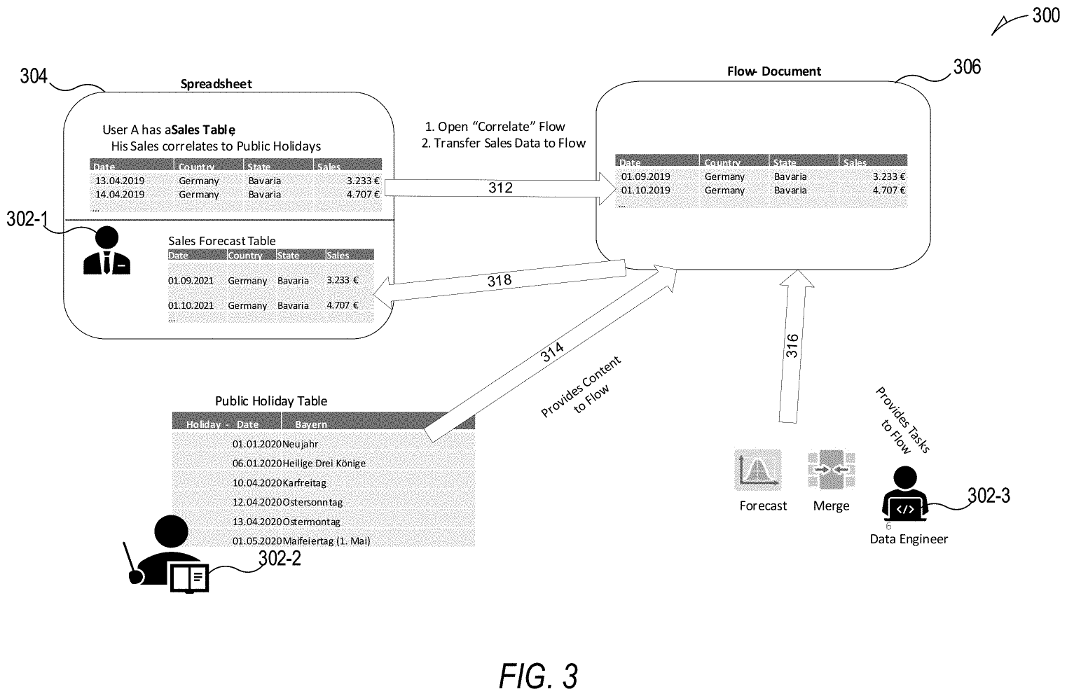

FIG. 3 is an example similar to FIG. 1 and FIG. 2 showing the process of sharing spreadsheet data with users in accordance with some embodiments. In this example, a first user 302-1 has a sales table within a spreadsheet application and shares 312 a portion of the sales table to flow document 306 (also referred to herein as a shared sandbox document as well as an add-in document). A sandbox document is similar to a sandbox application, which is a virtual container used to run and test software. The sandbox applications are designed to prevent software from damaging anything outside of the container while the software is being developed and tested. Similarly, the sandbox document discussed herein is a separate document that allows users to enter data, manipulate it, and share it without risking the fidelity of the rest of the data stored in their own proprietary documents.

Users 302-2 and 302-3 also contribute various information to the flow document 306. User 302-2 may contribute a portion of the user's public holiday table and user 302-3 may contribute one or more tasks or commands. The flow document 306 acts as a placeholder that accepts the portion of the sales table from user 302-1, the public holiday table from user 302-2, and one or more tasks from user 302-3. The one or more tasks from user 302-3 is run on the data and the first user 302-1 can pull 318 the resulting data (e.g., provide sales forecast data) from the flow document 306. The first user 302-1 now has a sales forecast table that includes information from user 302-2 and has been processed by one or more tasks from user 302-3.

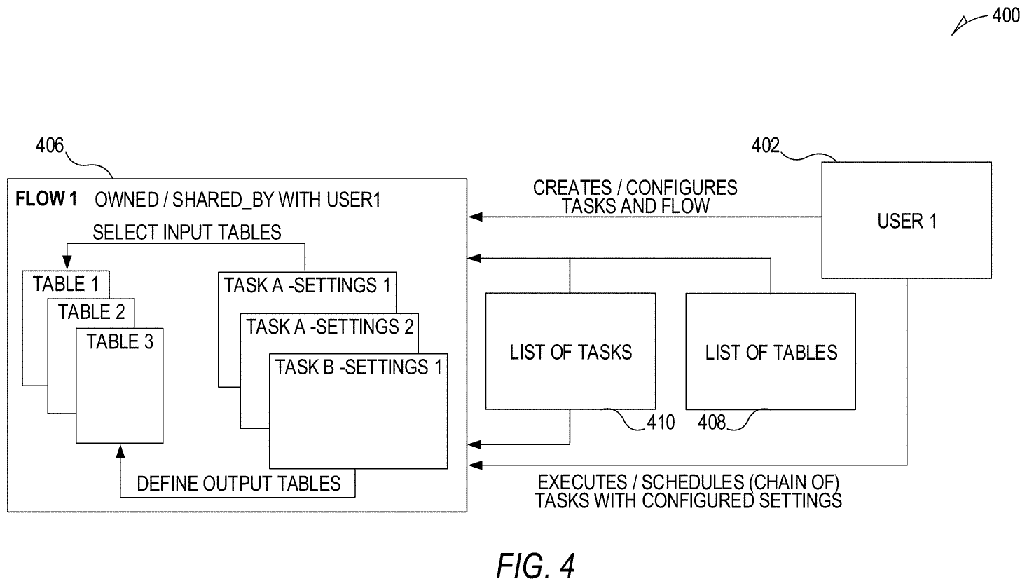

FIG. 4 is an example of a diagram showing a shared sandbox document and its relation to a user's electronic spreadsheet in accordance with some embodiments. A task is a function that is operable on data and may be strung together to create a larger or longer task. A task can be user defined and customized and is created and stored within a repository. The repository can be a public repository such as GitHub. The repository can be private to a corporation or group of users. There may be a separate repository for tables that are publicly or privately accessible. Both the tasks and tables can be selected by the user to be included in the shared document entitled flow 1. The shared document flow 1 406 may include one or multiple tasks such as Task A and Task B. Each task may have a defined setting or access permission requirement. User 1 may or may not be able to access the tasks within the shared document flow 1 406 based on the user's access permissions. Tables 1, 2, and 3 may each also have a defined setting or access permission requirement.

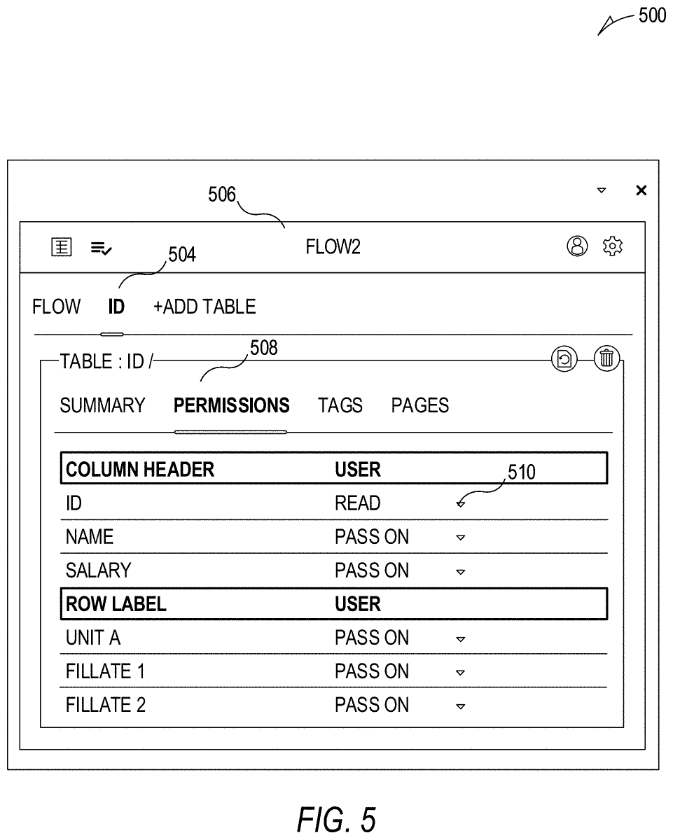

FIG. 5 is an example user interface 500 for an electronic spreadsheet application instance on a user device showing a shared document. As shown, the shared sandbox document 506 is entitled “Flow2” and includes various features and options. The option shown in 504 is to change access permissions 508 to specific portion of the user's data. The access permissions can be set by column and/or row. The various levels of access permissions can also be set as shown by the triangle icon 510 indicating there is a drop-down menu from which the user can select more access permissions. As seen in FIG. 4, a user may share multiple sandbox documents with different groups of users. For example, user 1 may have a first shared document, “Flow 1”, with users 2 and 3. User 1 may have a second shared document, “Flow 2”, shared with users 3 and 4. A user may have multiple shared sandbox documents based on the user's access permission or the access permission of a user within the group of users sharing the sandbox document.

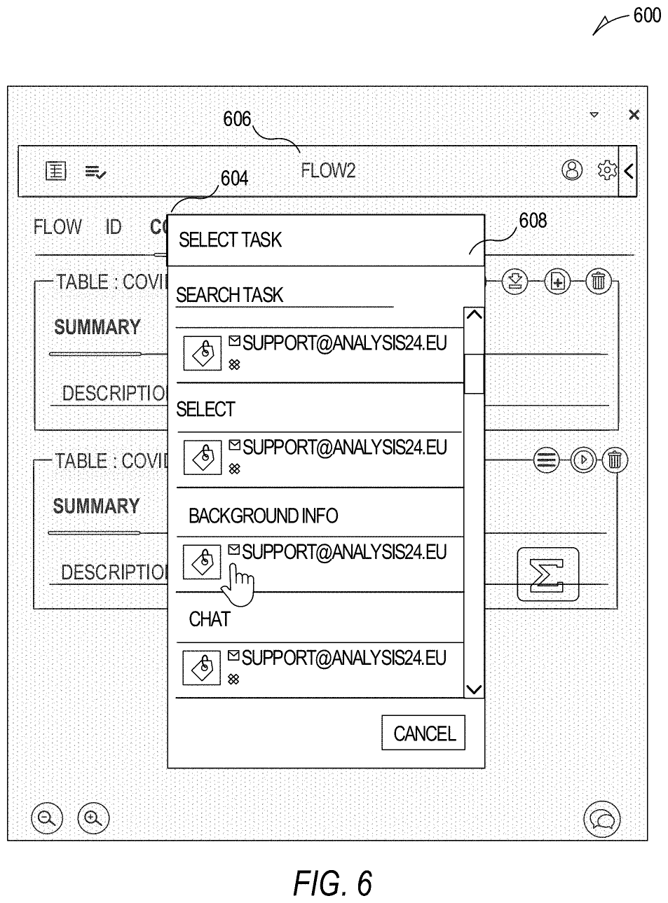

FIG. 6 is an example user interface 600 for an electronic spreadsheet application instance on a user device. The user interface 600 is a view of an interface allowing a user to define a task from within a sandbox document. As shown, the shard sandbox document 606 is entitled “Flow 2” (similar to the example shown in FIG. 5) and includes various features and options. The option shown in 604 is a popup window 608 to select one or more tasks to be applied to the selected table (“Covid”) partially hidden by the popup window.

The available tasks may be particular to a user and the user's access permissions. The user's access permissions may allow the user to share the user's tasks with another user or group of users. There may be more tasks that the user is not entitled to access and is not shown in the popup window. For example, the inaccessible tasks can be shown in the popup window but have a visual indicator that the task is inaccessible (e.g., the task is grey-ed out, crossed out, or an error message appears when trying to access the task). In some embodiments, a task can include a search task to search for a specific value within a dataset. In some embodiments, a task can include a select task to highlight or otherwise select a specific value within a dataset. In some embodiments, a task can include a background info task that may display one or more metadata pertaining to a dataset or other suitable background information. In some embodiments a task can include a chat task to allow the user to live chat with another user, a robot, a helpdesk, or other suitable entity.

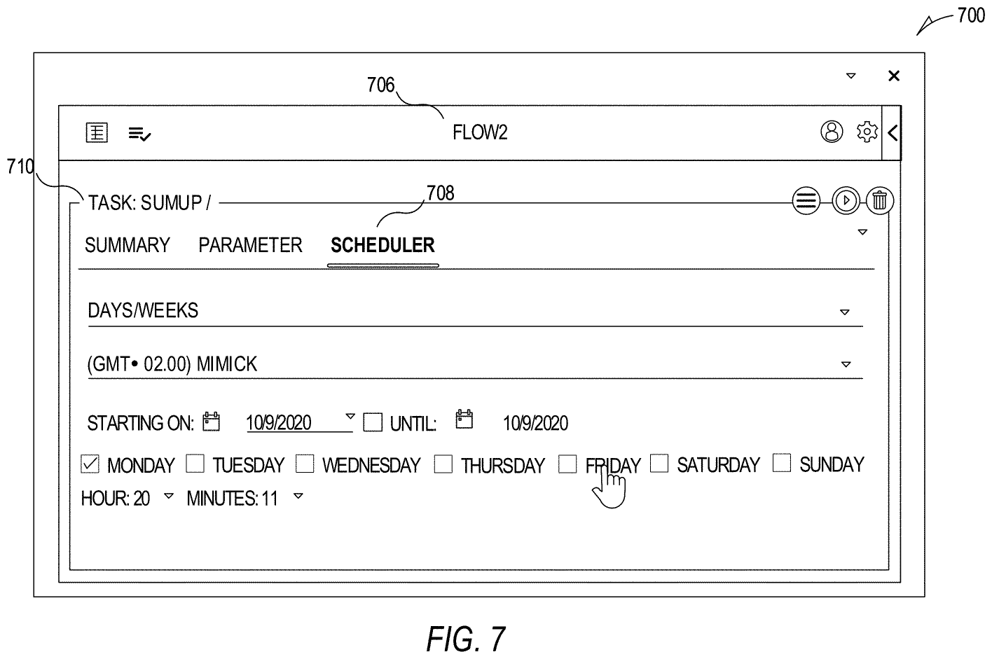

FIG. 7 is an example user interface 700 for an electronic spreadsheet application instance on a user device to schedule one or more tasks to run within a sandbox document. User interface 700 is a view of an interface allowing a user to schedule one or more tasks to run within sandbox document 706 entitled “Flow 2” (similar to the example shown in FIGS. 5 and 6) and includes various features and options. The option shown is a scheduler 708 option to set one or more tasks to run at a predetermined time. The user interface 700 allows a user to select which day and/or week to run the task 710 entitled “SUMUP.” Various other options include scheduling the task to run from a start date to an end date on specific days and for a specified duration.

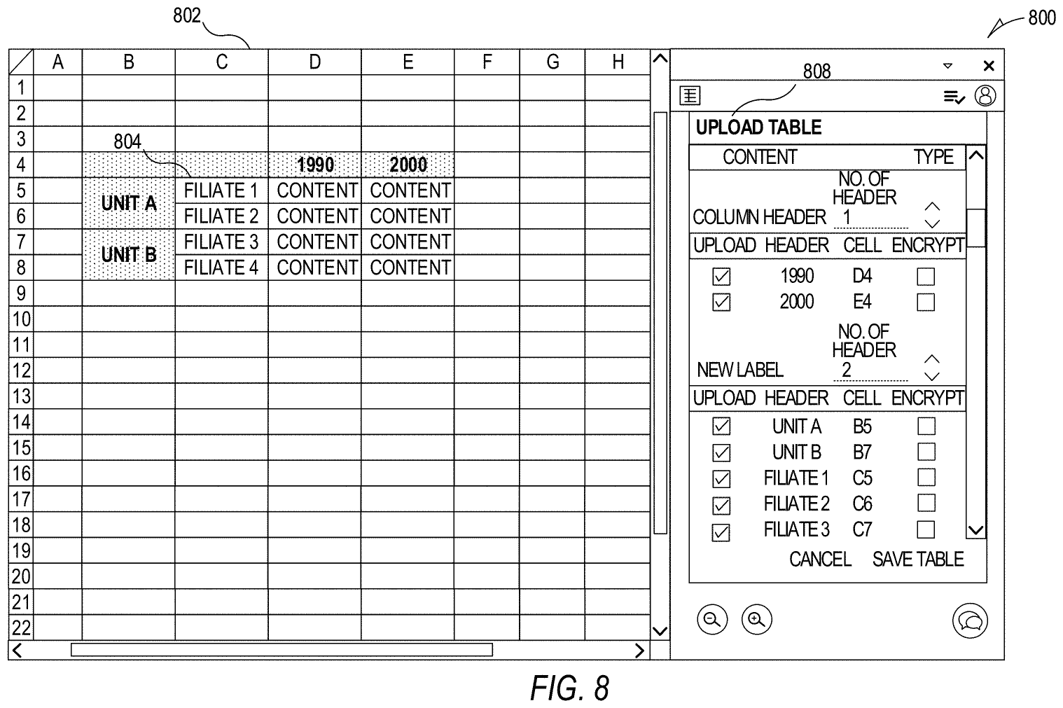

FIG. 8 is an example user interface for uploading a portion of data from a user's proprietary electronic spreadsheet application into a shared sandbox document. A user has an electronic spreadsheet 802 with data 804. A shared sandbox document is shown as a side menu 808 shown to the right of the spreadsheet. The side menu 808 allows the user to indicate what data is to be shared in the shared sandbox document. In some embodiments, the user can select all of the user's data to share in the shared sandbox document. In some embodiments, the user can encrypt the data shared to the shared sandbox document to provide an additional layer of security. In some embodiments, the encrypted data may be decrypted only by users with the required access permissions and may not be further passed through to other users.

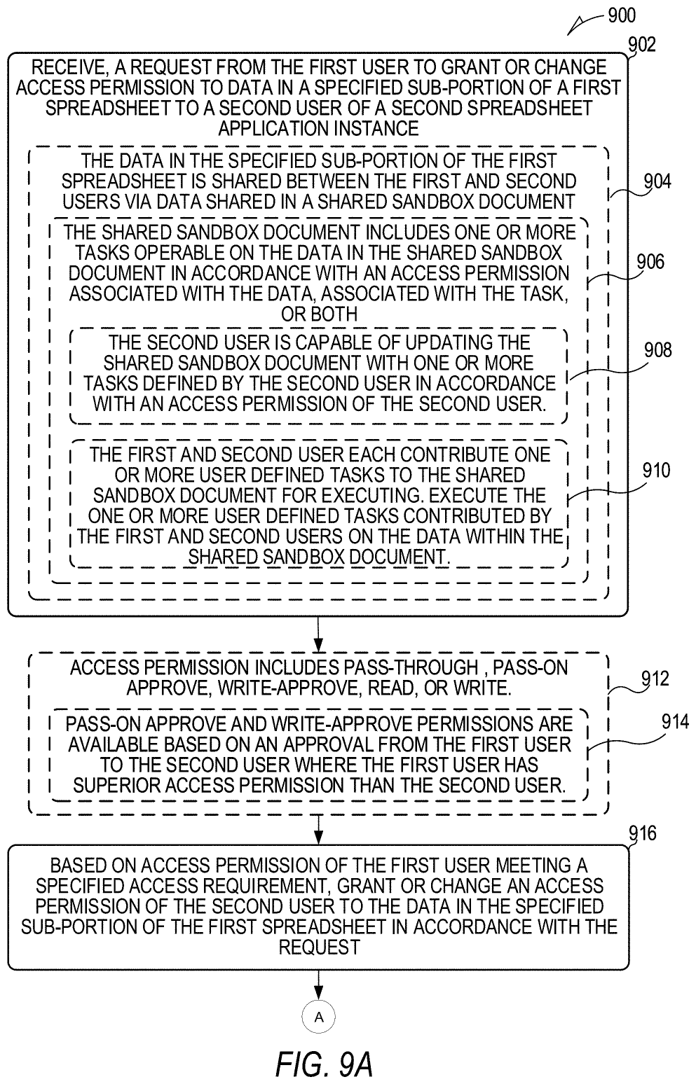

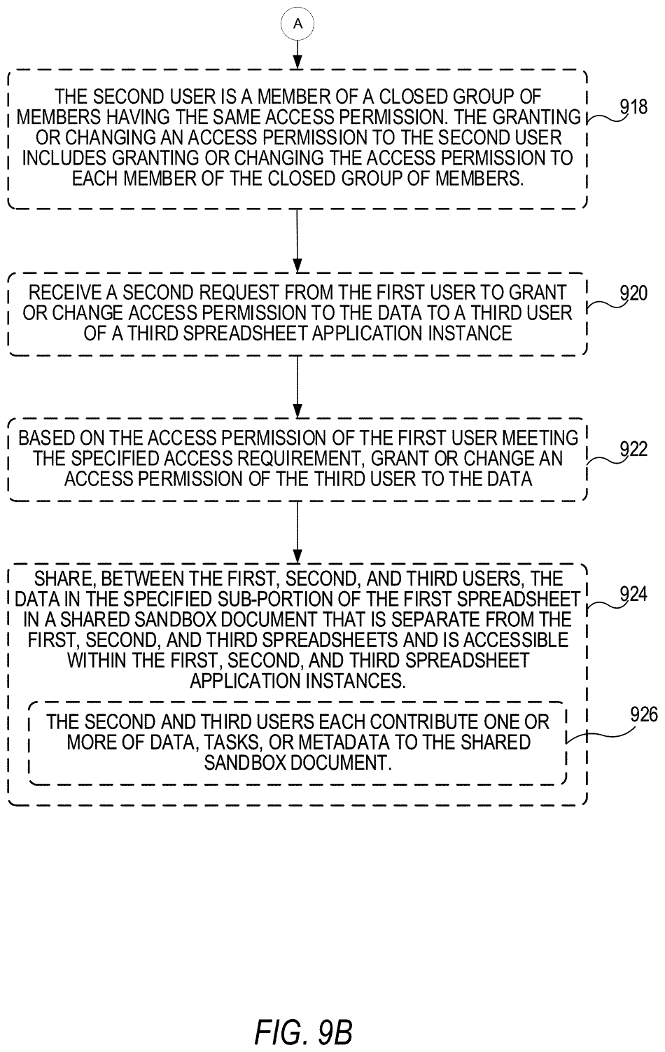

FIG. 9A-9B depict an example process 900 for sharing electronic spreadsheet data among multiple users according to some embodiments. Process 900 executes on a computing device such as data processing server 1202. Process 900 proceeds at 902 where a computing device (e.g., client device 1000) receives a request from a first user to grant or change access permission to data in a specified sub-portion of a first spreadsheet to a second user of a second spreadsheet application instance. In some embodiments, the sub-portion of the first spreadsheet may be a cell, a table, a worksheet, or an entire workbook of data.

In some embodiments, the data in the specified sub-portion of the first spreadsheet is shared between the first and second users via data shared in a shared sandbox document. The shared sandbox document may include various data types including tables, tasks, scheduled events, metadata, and data from other users. In some embodiments, the shared sandbox document includes (906) one or more tasks operable on the data in the shared sandbox document in accordance with an access permission associated with the data, associated with the task, or both. For example, the shared sandbox document is accessible by both the first and the second user. The sandbox document may include sensitive data accessible to the first user but not accessible by the second user based on each user's set access permissions. Additionally, the sandbox document may include one or more tasks available for access by the first user but not available for access by the second user based on the access permissions of the first and second users.

In some embodiments, the second user is (908) capable of updating the shared sandbox document with one or more tasks defined by the second user in accordance with an access permission of the second user. In some embodiments, the first and second user each contribute (910) one or more user defined tasks to the shared sandbox document for executing. The one or more user defined tasks are executed on the data within the shared sandbox document. Although the tasks that are available to each user may remain the same, the accessible data may differ from user to user. Additionally, and or alternatively, the available tasks to each user may differ and the accessible data may remain the same.

In some embodiments, access permissions include (912) pass-through, pass-on approve, write-approve, read, write, and none. The access permissions are in tiered level of access with pass-through being the highest and none being the lowest. Pass through permissions allow the user to give another user the same level of permissions that the user has. For example, user A has pass through permissions for reading and writing to dataset 1. User B does not have any access to dataset 1. Because user A has pass through permissions to read and write to dataset 1, user A can “pass” user A's permissions to user B. Thus, user B now has the same reading and writing permissions to dataset 1. In another example, user A has reading and writing permission to dataset 1 but does not have pass-through permissions. In such a situation, user A may not be able to grant user B read or write access to dataset 1.

Pass-on approve and write-approve permissions are (914) available based on approval from the first user to the second user where the first user has superior access permission than the second user. In other words, pass-on approve and write-approve permissions are permissions that the first user may grant to a second user so that the second user may also “pass-through” their access permission to a third user, regardless of the third user's access permissions.

In some embodiments, based (916) on access permission of the first user meeting a specified access requirement, grant or change an access permission of the second user to the data in the specified sub-portion of the first spreadsheet in accordance with the request.

The method 900 continues in FIG. 9B. In some embodiments, the second user is (918) a member of a closed group of members having the same access permission. The granting or changing of an access permission to the second user includes granting or changing of the access permission to each member of the closed group of members. For example, the first user is a director having a superior access permission and would like to grant access to her subordinate and her subordinate's teammates. Each teammate has the same access permission as the subordinate. Rather than spending time granting access to each person, the first user can grant her subordinate access permission to the sub-portion of the first spreadsheet which is propagated to each member of the subordinate's team.

In some embodiments, receive (920) a second request from the first user to grant or change access permission to the data in the sub-portion of the first spreadsheet to a third user of a third spreadsheet application instance. Based on the access permission of the first user meeting the specified access requirement, grant or change (922) an access permission of the third user to the data.

Between the first, second, and third users, share (924) the data in the specified sub-portion of the first spreadsheet in a shared sandbox document that is separate from the first, second, and third spreadsheets and is accessible from within the first, second, and third spreadsheet application instances. For example, if the first user shares a table to the shared sandbox document and the second user's access permissions only permit access to a subtable of the table, the second user is only privy to seeing the subtable to which the second user has access. The second user may not recognize that the subtable is only a portion of the shared table. The third user may have a higher access permission than the second user and may be privy to viewing and editing the entire shared table.

In some embodiments the second and third users each contribute (926) one or more of data, tasks, or metadata to the shared sandbox document. In some embodiments, there are multiple sandbox documents to be shared with distinct users.

For example, there is a first sandbox document for a first group of users and a second sandbox document for a second distinct group of users. In some embodiments, there is a single shared sandbox document accessible to multiple users. However, the single shared sandbox document may include data, tasks, metadata, and other functionalities that are not accessible to certain users without the required access requirement. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

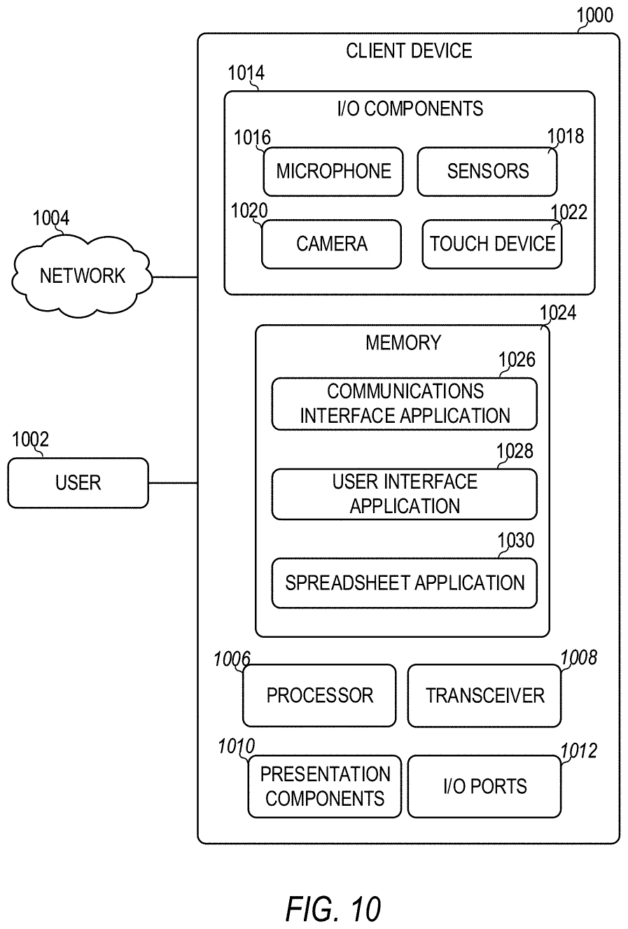

Referring to FIG. 10, a block diagram illustrates an example of a client device 1000 for collecting and providing user and environment data. In some examples, the client device 1000 has at least one processor 1006, a transceiver 1008, one or more presentation components 1010, one or more input/output (I/O) ports 1012, one or more I/O components 1014, and a memory 1024.

The client device 1000 may take the form of a mobile computing device or any other portable device, such as, a mobile telephone, laptop, tablet, computing pad, notebook, gaming device, etc. The client device 1000 may also include less portable devices such as desktop personal computers, kiosks, tabletop devices, industrial control devices, etc. Other examples may incorporate the client device 1000 as part of a multi-device system in which two separate physical devices share or otherwise provide access to the illustrated components of the computing device 1000.

The processor 1006 may include any quantity of processing units and is programmed to execute computer-executable instructions for implementing aspects of the disclosure. The instructions may be performed by the processor or by multiple processors within the computing device or performed by a processor external to the computing device. In some examples, the processor 1006 is programmed to execute methods such as the one illustrated in accompanying FIG. 9A-9B.

Additionally, or alternatively, some examples may make the processor 1006 programmed to present an experience in a user interface (“UI”), e.g., the UI shown in FIGS. 5-8. Moreover, in some examples, the processor 1006 may represent an implementation of techniques to perform the operations described herein. For example, the operations may be performed by an analog client device 1000 and/or a digital client device 1000.

The transceiver 1008 is an antenna capable of transmitting and receiving radio frequency (“RF”) signals. One skilled in the art will appreciate and understand that various antenna and corresponding chipsets may be used to provide communicative capabilities between the client device 1000 and other remote devices. Examples are not limited to RF signaling, however, as various other communication modalities may alternatively be used.

The presentation components 1010 visibly or audibly present information on the computing device 1000. Examples of presentation components 1010 include, without limitation, computer monitors, televisions, projectors, touch screens, phone displays, tablet displays, wearable device screens, televisions, speakers, vibrating devices, and any other devices configured to display, verbally communicate, or otherwise indicate spreadsheet data to a user. In some examples, the client device 1000 may be a smart phone or a mobile tablet that includes speakers capable of playing audible search results to the user. In other examples, the client device 1000 is a computer in a car that audibly presents search responses through a car speaker system, visually presents search responses on display screens in the car, e.g., situated in the car's dashboard, within headrests, on a drop-down screen, or the like, or a combination thereof. Other examples may present the disclosed search responses through various other display or audio presentation components 1010.

I/O ports 1012 allow the client device 1000 to be logically coupled to other devices and I/O components 1014, some of which may be built into client device 1000 while others may be external. Specific to the examples discussed herein, I/O components 1014 include a microphone 1016, one or more sensors 1018, a camera 1020, and a touch device 1022. The microphone 1016 captures speech from the user 1002 and/or speech of or by the user 1002. The sensors 1018 may include any number of sensors on or in a mobile computing device, electronic toy, gaming console, wearable device, television, vehicle, or other computing device 1000. Additionally, the sensors 1018 may include an accelerometer, magnetometer, pressure sensor, photometer, thermometer, global positioning system (“GPS”) chip or circuitry, bar scanner, biometric scanner for scanning fingerprint, palm print, blood, eye, or the like, gyroscope, near-field communication (“NFC”) receiver, or any other sensor configured to capture data from the user 1002 or the environment. The camera 1020 captures images or video of the user 1002. The touch device 1022 may include a touchpad, track pad, touch screen, or other touch-capturing device. The illustrated I/O components 1014 are but one example of I/O components that may be included on the client device 1000. Other examples may include additional or alternative I/O components 1014, e.g., a sound card, a vibrating device, a scanner, a printer, a wireless communication module, or any other component for capturing information related to the user or the user's environment.

The memory 1024 includes any quantity of memory associated with or accessible by the computing device 1000. The memory 1024 may be internal to the client device 1000, as shown in FIG. 10, external to the client device 1000, not shown in FIG. 10, or both. Examples of memory 1024 may include, without limitation, random access memory (RAM), read only memory (ROM), electronically erasable programmable read only memory (EEPROM), flash memory or other memory technologies, CDROM, digital versatile disks (DVDs) or other optical or holographic media, magnetic cassettes, magnetic tape, magnetic disk storage or other magnetic storage devices, memory wired into an analog computing device, or any other medium for encoding desired information and for access by the client device 1000. Memory 1024 may also take the form of volatile and/or nonvolatile memory; may be removable, non-removable, or a combination thereof; and may include various hardware devices, e.g., solid-state memory, hard drives, optical-disc drives, etc. Additionally, or alternatively, the memory 1024 may be distributed across multiple client devices 1000, e.g., in a virtualized environment in which instruction processing is carried out on multiple client devices 1000. The memory 1024 stores, among other data, various device applications that, when executed by the processor 1006, operate to perform functionality on the computing device 1000. Examples of applications may include search applications, instant messaging applications, electronic-mail application programs, web browsers, calendar application programs, address book application programs, messaging programs, media applications, location-based services, search programs, and the like. The applications may communicate with counterpart applications or services such as web services accessible via the network 1004. For example, the applications may include client-operating applications that correspond to server-side applications executing on remote servers or computing devices in the cloud.

Specifically, instructions stored in memory 1024 comprise a communications interface application 1026, a user interface application 1028, and a spreadsheet application 1030. In some examples, the communications interface application 1026 includes computer-executable instructions for operating a network interface card and/or a driver for operating the network interface card. Communication between the client device 1000 and other devices may occur using any protocol or mechanism over a wired or wireless connection, or across the network 1004. In some examples, the communications interface application 1026 is operable with RF and short-range communication technologies using electronic tags, such as NFC tags, Bluetooth® brand tags, or the like.

In some examples, the user interface application 1028 includes a graphics application for displaying data to the user and receiving data from the user. The user interface application 1028 may also include computer-executable instructions for operating the graphics card to display electronic spreadsheet data and corresponding images or speech on or through the presentation components 1010. The user interface application 1028 may also interact with the various sensors 1018 and camera 1020 to both capture and present information through the presentation components 1010.

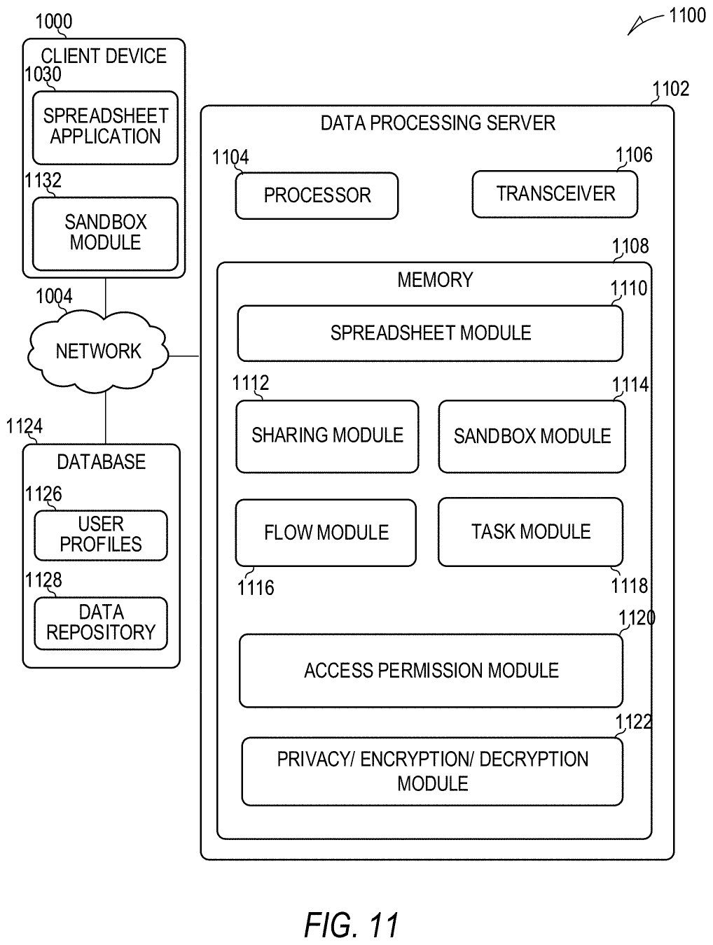

FIG. 11 is a block diagram of a networking environment 1100 for sharing electronic spreadsheet data with multiple users on client device(s) 1000. The networking environment 1100 may include multiple client devices 1000, or just one as shown in FIG. 11, a data processing server 1102, and a database 1124 communicating over a network 1004. In some examples, user and environment data are communicated by the client devices 1000 over the network 1004 to the data processing server 1102, and the data processing server 1102 generates data with altered access permissions that are provided back to the client devices 1000 for presentation to their respective users 1002.

The networking environment 1100 shown in FIG. 11 is merely an example of one suitable computing system environment and is not intended to suggest any limitation as to the scope of use or functionality of examples disclosed herein. Neither should the illustrated networking environment 1100 be interpreted as having any dependency or requirement related to any single component, module, index, or combination thereof.

The network 1004 may include any computer network, for example the Internet, a private network, local area network (LAN), wide area network (WAN), or the like. The network 1004 may include various network interfaces, adapters, modems, and other networking devices for communicatively connecting the client devices 1000, the data processing server 1102, and the database 1124. The network 1004 may also include configurations for point-to-point connections. Computer networks are well known to one skilled in the art, and therefore do not need to be discussed in detail herein.

The client devices 1000 may be any type of client device discussed above in reference to FIG. 10. Each client device 1000 may capture user and/or environment data from their respective users and communicate the captured user and environment data over the network 1004 to the data processing server 1102 and/or the database 1124. To do so, each device may be equipped with a communications interface application 1026, as discussed above in reference to FIG. 10.

The client device 1000 may be equipped with various software applications and presentation components 1010 for storing, using, and sharing electronic spreadsheet data. For example, a laptop device of a user may have one or more applications installed. One of the applications is an instance of an electronic spreadsheet application for use by the user. The user wishes to share a portion of the data within the electronic spreadsheet application without relying on external permissions setting systems to grant access to the portion of the data to another user. The user can, from within the spreadsheet application, grant or change an access permission of the recipient to allow access to the user's data. The illustrated client devices and the aforesaid presentation mechanisms are not an exhaustive list covering all examples. Many different variations of client devices 1000 and presentation techniques may be used to share electronic spreadsheet data with multiple users.

The data processing server 1102 represents a server or collection of servers configured to execute different web-service computer-executable instructions. The data processing server 1102 includes a processor 1104 to process executable instructions, a transceiver 1106 to communicate over the network 1004, and a memory 1108 embodied with at least the following executable instructions: a spreadsheet module 1110, a sharing module 1112, and a sandbox module 1114. The memory 1108 may also include instructions for flow module 1116, task module 1118, access permission module 1120, and privacy/encryption/decryption module 1122. The privacy/encryption/decryption module may retrieve encrypted data tables and decrypt the data tables before transferring the data tables for use by another module. There may be additional modules such as a database processor to erase decrypted data tables that are no longer necessary for use. It is appreciated that various methods are available to maintain data privacy and integrity and any suitable method may be used in conjunction with the described methods and systems. In some embodiments, the tasks may also be encrypted and require decryption before use. While data processing server 1102 is illustrated as a single box, one skilled in the art will appreciate that the data processing server 1102 may, in fact, be scalable. For example, the data processing server 1102 may include multiple servers operating various portions of software that collectively facilitate sharing electronic spreadsheet data with multiple users on the client device(s) 1000.

The database 1124 provides backend storage of Web, user, and environment data that may be accessed over the network 1004 by the data processing server 1102 or the client devices 1000 and used by the data processing server 1102 to share electronic spreadsheet data with multiple users. The Web, user, and environment data stored in the database includes, for example but without limitation, user profiles 1126, data repository 1128 and so on. Additionally, though not shown for the sake of clarity, the servers of the database 1124 may include their own processors, transceivers, and memory. Also, networking environment 1100 depicts the database 1124 as a collection of separate devices from the data processing server 1102; however, examples may store the discussed Web, user, and environment data shown in the database 1124 on the data processing server 1102.

In the description herein, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

It will also be understood that, although the terms first, second, etc., are, in some instances, used herein to describe various elements, these elements should not be limited by these terms. These terms are used only to distinguish one element from another. For example, a first user could be termed a second user, and similarly, a second user could be termed a first user without departing from the scope of the various described embodiments. The first user and the second user are both users, but they are not the same user.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

1. A method of sharing electronic spreadsheet data among multiple users, the method comprising:
receiving, from within a first spreadsheet application instance on a first electronic device of a first user, a request from the first user to grant or change access permission to data in a specified sub-portion of a first spreadsheet to a second user of a second spreadsheet application instance on a second electronic device of the second user; and
based on an access permission of the first user meeting a specified access requirement, from within the spreadsheet application on the electronic device of the first user, granting or changing an access permission of the second user to the data in the specified sub-portion of the first spreadsheet in accordance with the request.

2. The method of claim 1, wherein data in the specified sub-portion of the first spreadsheet is shared between the first and second users via data in a shared sandbox document that is separate from the first and second spreadsheets, wherein the shared sandbox document is accessible from within the first and second spreadsheet application instances.

3. The method of claim 2, wherein the shared sandbox document includes one or more tasks operable on the data in the shared sandbox document in accordance with an access permission associated with the data, associated with the task, or both.

4. The method of claim 1, wherein the access permission further includes at least one of pass-through sharing, pass-on approve, write-approve, read, or write.

5. The method of claim 4, wherein the pass-on approve and write-approve permissions are available based on an approval from the first user to the second user wherein the first user has superior access permission than the second user.

6. The method of claim 1, wherein the second user is a member of a closed group of members having a same access permission, and the granting or changing an access permission to the second user includes granting or changing the access permission to each member of the closed group of members.

7. The method of claim 3, wherein the second user is capable of updating the shared sandbox document with one or more tasks defined by the second user in accordance with an access permission of the second user.

8. The method of claim 3, wherein the first user and the second user each contribute one or more user defined tasks to the shared sandbox document for executing; and
executing the one or more user defined tasks contributed by the first and second users on the data within the sandbox.

9. The method of claim 1, further comprising:
receiving, from within the first spreadsheet application instance on the first electronic device of the first user, a second request from the first user to grant or change access permission to the data in the specified sub-portion of the first spreadsheet to a third user of a third spreadsheet application instance on a third electronic device of the third user;
based on the access permission of the first user meeting the specified access requirement, from within the spreadsheet application on the electronic device of the first user, granting or changing an access permission of the third user to the data in the specified sub-portion of the first spreadsheet; and
sharing, between the first, second, and third users, the data in the specified sub-portion of the first spreadsheet in a shared sandbox document that is separate from the first, second, and third spreadsheets and is accessible from within the first, second, and third spreadsheet application instances.

10. The method of claim 9, wherein the second and third users each contribute one or more of data, tasks, or metadata to the shared sandbox document.

11. A system for sharing electronic spreadsheet data among multiple users, comprising:
a processor; and
a memory device coupled to the processor and having a program stored thereon for execution by the processor to perform operations comprising:
receiving, from within a first spreadsheet application instance on a first electronic device of a first user, a request from the first user to grant or change access permission to data in a specified sub-portion of a first spreadsheet to a second user of a second spreadsheet application instance on a second electronic device of the second user; and
based on an access permission of the first user meeting a specified access requirement, from within the spreadsheet application on the electronic device of the first user, granting or changing an access permission of the second user to data in the specified sub-portion of the first spreadsheet.

12. The system of claim 11, wherein data in the specified sub-portion of the first spreadsheet is shared between the first and second users via a shared sandbox document that is separate from the first spreadsheet, wherein the shared sandbox document is accessible from within the first and second spreadsheet application instances.

13. The system of claim 12, wherein the shared sandbox document includes one or more tasks operable on data in the shared sandbox document in accordance with an access permission associated with the data, associated with the task, or both.

14. The system of claim 13, wherein the first user and the second user each contribute one or more user defined tasks to the shared sandbox document for executing; and
executing the one or more user defined tasks on the data within the sandbox.

15. The system of claim 11, further comprising:
receiving, from within the first spreadsheet application instance on the first electronic device of the first user, a second request from the first user to grant or change access permission to the data in the specified sub-portion of the first spreadsheet to a third user of a third spreadsheet application instance on a third electronic device of the third user; and
based on the access permission of the first user meeting the specified access requirement, from within the spreadsheet application on the electronic device of the first user, granting or changing an access permission of the third user to the data in the specified sub-portion of the first spreadsheet; and
sharing, between the first, second, and third users, the data in the specified sub-portion of the first spreadsheet in a shared sandbox document that is separate from the first, second, and third spreadsheets and is accessible from within the first, second, and third spreadsheet application instances.

16. The system of claim 15, wherein the second and third users each contribute one or more of data, tasks, or metadata to the shared sandbox document.

17. A non-transitory computer readable storage medium storing one or more programs for sharing electronic spreadsheet data among multiple users, the one or more programs comprising instructions which when executed by one or more processors of an electronic device, cause the electronic device to:
receive, from within a first spreadsheet application instance on a first electronic device of a first user, a request from the first user to grant or change access permission to data in a specified sub-portion of a first spreadsheet to a second user of a second spreadsheet application instance on a second electronic device of the second user; and
based on an access permission of the first user meeting a specified access requirement, from within the spreadsheet application on the electronic device of the first user, grant or change an access permission of the second user to the data in the specified sub-portion of the first spreadsheet.

18. The storage medium of claim 17, wherein data in the specified sub-portion of the first spreadsheet is shared between the first and second users via a shared sandbox document that is separate from the first spreadsheet, wherein the shared sandbox document is accessible from within the first and second spreadsheet application instances.

19. The storage medium of claim 18, wherein the shared sandbox document includes one or more tasks operable on data in the shared sandbox document in accordance with an access permission associated with the data, associated with the task, or both.

20. The storage medium of claim 19, wherein the first user and the second user each contribute one or more user defined tasks to the sandbox document for executing; and
executing the one or more user defined tasks on the data within the sandbox.
